(19) United States
(12) Patent Application Publication
(10) Pub. No.: US 2010/0045295 A1
(43) Pub. Date: Feb. 25, 2010

(54) METHOD AND APPARATUS FOR DETERMINING THE NATURE OF SUBMARINE RESERVOIRS

(75) Inventors: Rune Mittet, Trondheim (NO); Hans-Roger Jensen, Trondheim (NO); Frank A. Maao, Trondheim (NO); Svein Ellingsrud, Trondheim (NO)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(73) Assignee: ELECTROMAGNETIC GEOSERVICES ASA, Trondheim (NO)

(21) Appl. No.: 12/441,365

(22) PCT Filed: Sep. 13, 2007
(86) PCT No.: PCT/GB2007/003484

§ 371 Date: Sep. 24, 2009

(30) Foreign Application Priority Data
Sep. 15, 2006 (GB) 0618238.0

(51) Int. Cl. G01V 3/00

(52) U.S. Cl. 324/334

(57) ABSTRACT

A method of producing a survey report on the presence and nature of a subterranean strata: includes simultaneously towing an EM field transmitter and a seismic source behind a vessel, towing at least one streamer behind the vessel, said streamer or streamers having EM field receivers for measuring an electric field and seismic receivers for measuring a seismic response, applying an EM field to the strata using the EM field transmitter and detecting an EM field response using the EM field receivers, applying a seismic event to the strata using the seismic source and detecting the seismic response using the seismic receivers, analysing the EM field response, analysing the seismic responses and reconciling the EM field response and the seismic response to produce the survey report.

### PRIORITY CLAIM

The present application is a National Phase entry of PCT Application No. PCT/GB2007/003484, filed Sep. 13, 2007, which claims priority from Great Britain Application Number 0618238.0, filed Sep. 15, 2006, the disclosures of which are hereby incorporated by reference herein in their entirety.

### TECHNICAL FIELD

The present invention relates to a method and apparatus for detecting and determining the nature of submarine and subterranean reservoirs. The invention is particularly suitable for determining the properties and extent of a reservoir, in particular whether it contains hydrocarbons or not, by using a combination of electromagnetic (EM) and seismic surveys.

### BACKGROUND

Geological surveying, particularly in sub-marine situations, is primarily conducted using seismic methods. These seismic techniques are capable of revealing the structure of the subterranean strata with some accuracy. However, whereas a seismic survey can reveal the location and shape of a potential reservoir, it can normally not reveal the nature of the reservoir. Traditionally, therefore, the solution has been to drill a borehole into the reservoir. However, the costs involved in drilling an exploration well tend to be in the region of approximately $41 million present value and since the success rate is generally about 1 in 10, this tends to be a very costly exercise.

While the seismic properties of hydrocarbon filled strata and water-filled strata do not differ significantly, their EM resistivities do differ. Thus, by using an EM surveying method, these differences can be exploited and the success rate in predicting the nature of a reservoir can be increased significantly.

Consequently, a method of determining the nature of a subterranean reservoir whose approximate geometry and location are known, has been set out in, for example, WO01/57555.Said method may comprise: applying a time varying EM field to the strata containing the reservoir; detecting the EM field response; seeking in the field response, a component representing a refracted wave from the hydrocarbon layer; and determining the content of the reservoir, based on the presence or absence of a wave component refracted by the hydrocarbon layer.

A refracted wave behaves differently, depending on the nature of the stratum in which it is propagated. In particular, the propagation losses in hydrocarbon stratum are much lower than in a water-bearing stratum while the speed of propagation is much higher. Thus, when a hydrocarbon or oil-bearing reservoir is present, and an EM field is applied, a strong and rapidly propagated refracted wave can be detected. This may therefore indicate the presence of the reservoir or its nature if its presence is already known.

WO2004/083898 discloses a system for investigating subterranean strata in which an EM field and a seismic event are applied from the same location and the response are detected using respective receivers both located at a second location spaced from the first. The responses are combined to identify the presence and/or the nature of subterranean reservoir.

### SUMMARY OF THE INVENTION

It is an object of the present invention to provide a method and apparatus for reliably locating and identifying submarine reservoirs, in particular hydrocarbon reservoirs, using simultaneous measurements from seismic and EM data, at a reduced cost and with reduced operational requirements.

According to one aspect of the invention, there is provided a method of producing a survey report of subterranean strata which comprises: simultaneously towing an EM field transmitter and a seismic source behind a vessel; towing at least one streamer behind the same vessel, said streamer or streamers having EM field receivers for measuring the electric field and seismic receivers for measuring the seismic response; applying an EM field to the strata using the EM field transmitter and detecting the EM field response using the EM field receivers; applying a seismic event to the strata using the seismic source and detecting the seismic response using the seismic receivers; analysing the EM field responses; analysing the seismic responses and reconciling the two responses, in order to produce a report on the presence and nature of the strata.

The method may include extracting and using phase and/or amplitude information from the responses. The method may also include identifying the refracted wave component of the EM field responses, identifying the reflected (and/or refracted) wave component of the seismic responses, and using the identified wave components to produce the survey report. Phase and/or amplitude information from the identified wave components may be used.

The EM field transmitter can comprise an electric dipole antenna, and the EM field receivers can comprise electric dipole antenna.

### BRIEF DESCRIPTION OF THE DRAWINGS

The present invention may be put into practice in a number of ways and examples follow with reference to the following figures, in which:

FIG. 1 is a schematic plan view of an embodiment of the present invention;

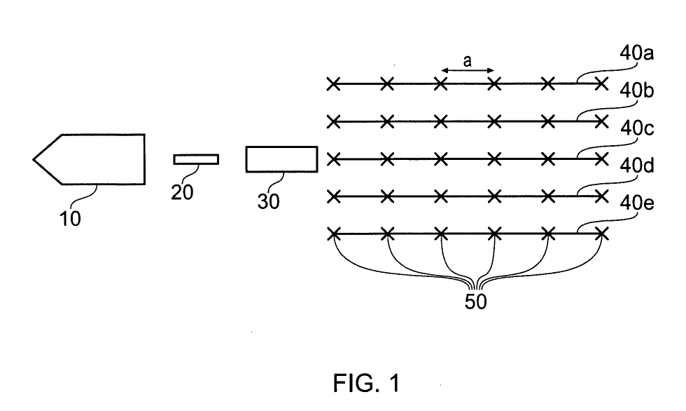

FIG. 2 is a schematic plan view of an embodiment of the present invention;

FIG. 3 is a schematic side elevation view of an embodiment of the present invention;

FIG. 4 is a schematic side elevation view of an embodiment of the present invention;

FIG. 5 is a schematic side elevation view of an embodiment of the present invention; and

FIG. 6 is a schematic side elevation view of an embodiment of the present invention.

### DETAILED DESCRIPTION OF THE DRAWINGS

While longer wavelengths applied by EM techniques cannot provide sufficient information to provide an accurate indication of the boundaries of the various strata they can be used to determine the nature of a particular identified formation, if the possibilities for the nature of that formation have significantly differing EM characteristics. The resolution is not particularly important and so longer wavelengths which do not suffer from excessive attenuation can be employed.

Seismic surveying techniques, however can detect the boundaries of subterranean strata with some accuracy, but cannot readily identify the nature of strata located. Thus by using both techniques, the results can be combined and potential hydrocarbon bearing reservoirs can be identified with greater certainty.

There are generally three contributions to the measured signal that correspond to propagation along different paths between the source and the receiver: the direct signal, the reflected signal, and the refracted signal. The refracted signal is caused by a leaky wave-guide mode that is excited in the layer and, in the limit of an infinitely thick layer, it is transformed into a lateral wave or head-wave that is propagated along the upper interface but inside the layer.

In the EM case the refracted wave is strongly excited only with the transmitter and receiver dipole antennae in-line. As functions of the offset distance, both the phase delay and exponential damping of this wave will only depend on the properties of the layer, i.e. the layer-thickness and the resistivity contrast relative to the overburden. In this case the direct wave is quite weak and, with a low-resistivity overburden, both the direct wave and the reflected wave are strongly damped for large offsets. With a broadside dipole antenna arrangement, there is a stronger direct and a much weaker refracted wave, so that contributions are mainly seen from the direct and the reflected waves.

Both the phase and the amplitude of the refracted wave depend on the thickness and relative resistivity of the layer, and these dependencies are expressed by simple mathematical formulae that can be utilized for quantitative measurements. However, the amplitude also has an additional offset dependence caused by the geometrical wave spreading in the layer. Therefore, phase measurements combined with amplitude measurements will yield maximum information about the nature of the layer. Additional information can be obtained by recording at different frequencies and utilizing the known frequency dependence of the phase and amplitude of the refracted wave.

In an embodiment, the EM field response is analysed to identify the refracted wave component and the seismic response is analysed to identify the reflected component. Then, the two identified wave components are used to determine the presence and nature of the strata. Preferably, the system additionally includes extracting and using phase and/or amplitude information from the responses.

Additionally, the method may include deploying a magnetic receiver at the same location as the other receivers; detecting a magnetic field response; and using the magnetic field response in combination with the EM field response and the seismic response. As with the electric field, the magnetic field response is caused both by the EM transmission and the magneto telluric signal that is always present as a noise background.

The resistivity of seawater is about 0.3 ohm-m and that of the overburden beneath the seabed would typically be from 0.5 to 4 ohm-m, for example about 2 ohm-m. However, the resistivity of a hydrocarbon reservoir is likely to be about 20-300 ohm-m. Typically, therefore, the resistivity of a hydrocarbon-bearing formation will be 20 to 300 times greater than that of a water-bearing formation. This large difference can be exploited using EM techniques.

The electrical resistivity of a hydrocarbon reservoir normally is far higher than the surrounding material (overburden). EM-waves attenuate more rapidly, and travel slower inside a low resistivity medium, compared to a high resistivity medium. Consequently, hydrocarbon reservoir will attenuate EM-waves less, compared to a lower resistivity overburden. Furthermore, the EM-wave speed will be higher inside the reservoir.

Thus, an electric dipole transmitter antenna close to the sea floor induces EM fields and currents in the sea water and in the subsurface strata. In the sea water, the EM-fields are strongly attenuated due to the high conductivity in the saline environment, whereas the subsurface strata with less conductivity causes less attenuation. If the frequency is low enough (in the order of 1 Hz), the EM energy is able to penetrate deep into the subsurface, and deeply buried geological layers having higher electrical resistivity than the overburden (as e.g. a hydrocarbon filled reservoir) will affect the EM-waves. Depending on the angle of incidence and state of polarisation, an EM wave incident upon a high resistive layer may excite a ducted (guided) wave mode in the layer. The ducted mode is propagated laterally along the layer and leaks energy back to the overburden and receivers positioned on the sea floor. In the present application, such a wave mode is referred to as a “refracted wave.”

The distance between the EM source and a receiver is referred to as the offset. Due to the fact that a refracted wave in a hydrocarbon-bearing formation will be less attenuated than a direct wave in seawater (or in the overburden), for any given hydrocarbon bearing formation, there will be a critical offset at which the refracted wave and the direct wave will have the same signal strength. This may typically be about two to three times greater than the shortest distance from the source or receiver to the hydrocarbon bearing formation. Thus, when the offset is greater than the critical offset, the radial EM waves that are refracted into, and guided through the reservoir, will pay a major contribution to the received signal. The received signal will be of greater magnitude and arrive earlier (i.e. have less phase shift) compared to the case where there is no hydrocarbon reservoir. In many cases, the phase change and/or magnitude change recorded at distances greater than the critical offset may be directly used for calculation of the reservoir resistivity. Furthermore, the reservoir depth may be inferred from the critical offset and/or the slope of a curve representing recorded signal phase shift or recorded signal magnitude as a function of transmitter-receiver offset. The most useful EM source-receiver offset is typically larger than the “critical offset.” At offsets larger than the critical offset, a change in the slope of a curve representing recorded signal phase shift or recorded signal magnitude as a function of the source-receiver offset may indicate the reservoir boundary.

If the offset between the EM transmitter and EM receiver is significantly greater than three times the depth of a reservoir from the seabed (i.e. the thickness of the overburden), it will be appreciated that the attenuation of the refracted wave from the reservoir will often be less than that of the direct wave and the reflected wave. The reason for this is the fact that the path of the refracted wave will be effectively the distance from the transmitter down to the reservoir i.e. the thickness of the overburden, plus the offset along the reservoir, plus the distance from the reservoir up to the receivers i.e. once again the thickness of the overburden.

If no hydrocarbon reservoir is present in the area of the EM transmitter and receiver, the detected field response will consist of a direct wave and possibly a reflected wave. It will therefore be strongly attenuated and its phase will change rapidly with increasing offset.

However, if a hydrocarbon reservoir is present, there will be a refracted wave component in the field response and this may predominate. Due to the higher phase velocity (wavespeed) in hydrocarbon filled strata, this will have an effect on the phase of the received field response.

As a function of offset between source and receiver, the phase of the refracted wave will change almost linearly and much slower than the phases of the direct and reflected waves and, since the latter waves are also much more strongly attenuated with increasing offset, there will be a transition from a rapid phase variation to a slow phase variation with nearly constant slope, indicating the presence of the hydrocarbon reservoir. If the edge of the reservoir is crossed, this slow phase variation will change to a rapid phase variation and strong attenuation. Thus, for large offsets, a change from a slow, linear phase variation to a rapid one, or vice versa, will indicate the boundary of a hydrocarbon reservoir.

With a constant offset being maintained between transmitter and receiver while the position of both over the survey area is varied as the vessel moves, the recorded phase shift should be constant as long as the resistivity of the subsurface strata below and between the source and receiver is constant. If a change in phase shift is detected while moving, this would indicate that one of the instruments is in the vicinity of the boundary of a hydrocarbon reservoir. Further, a change in the amplitude of the response would be expected around the boundary of the reservoir.

The polarization of the source transmission will determine how much energy is transmitted into the oil-bearing layer in the direction of the receiver. A dipole antenna is therefore the selected transmitter. In general, it is preferable to adopt a dipole for which the current moment, i.e. the product of the current and the effective length, is large. The transmitter dipole may therefore be 100 to 1000 meters in length and may be towed in two different directions, which may be orthogonal. The receiver dipole optimum length is determined by the current moment of the source dipole and the thickness of the overburden.

The transmitted EM field may be of any suitable form, for example a pulsed or a coherent continuous wave which may or may not have stepped frequencies. For a pulsed field, the field may be transmitted for a period of time from 3 seconds to 60 minutes, for example from 10 seconds to 5 minutes, for example about 1 minute. For a continuous field, the transmission may have a duration of several hours or even days. The EM receivers may also be arranged to detect a direct and a reflected wave as well as the refracted wave from the reservoir, and the analysis may include distinguishing phase and amplitude data of the refracted wave from corresponding data from the direct wave.

The transmission frequency may be from 0.01 Hz to 1 kHz, preferably from 0.1 to 20 Hz, for example 1 Hz. The wavelength of the transmission may be in the range 0.1 s≦λ≦5 s; where λ is the wavelength of the transmission through the overburden and s is the distance from the seabed to the reservoir. More preferably λ is from about 0.5 s to 2 s.

Typically a first receiver on the streamer may be about 100 m behind the rear of the vessel, or may be in the range of 50-500 m behind the vessel. Receivers may then be placed at regular intervals every few metres, for example every 1 m, every 2 m, every 5 m, every 10 m etc. Alternatively, the receivers may be set at irregular intervals in the range 1-50 m. The separation between EM receivers and seismic receivers on streamers may be the same or different. The separation of different streamers behind the vessel may be the same or different.

The vessel may tow any number of streamers, for example a single “mixed” streamer or a multitude of streamers from 2-30, for example 2-6, 4-8, 10-20, 16-20, 20-30 streamers etc. The streamers may be arranged to be regular distances apart or they may be at different separations. The separations are preferably regular and fall within the range 50-250 m, for example 50-150, for example 75-100 m apart.

The streamers may be of any suitable length for the area being surveyed and the level of detail required. The streamers are preferably each of the same length although they could be of different lengths. The streamers are preferably between 500 m and 10 km long, for example between 1-8 km, for example 3-7 km, for example 4-6 km.

The EM signals are sensitive to the electrical resistivity of subterranean layers and, therefore, EM methods are well suited for the detection of high resistive layers such as H/C reservoirs. However, layers without hydrocarbons may also have high electrical resistivities, e.g. layers consisting of salt, basalt, calcite strings, or other dense rocks with low porosities and low water contents. High-resistive layers of this type will generally have higher seismic velocities than the low-resistive overburden, whereas high-resistive hydrocarbon reservoirs generally have lower seismic velocities than the low-resistive overburden. Seismic data can therefore be used to distinguish high resistive hydrocarbon reservoirs from other high resistive layers. The combination of EM and seismic data therefore. By recording both wave types in the same survey, it is possible to obtain a more reliable identification of hydrocarbon reservoirs.

The EM field transmitter may be towed close to the seabed, preferably within the range 25-60 m from the sea bed, more preferably within the range 30-45 m from the sea bed. The seismic source may be towed at a shallow depth, preferably at a depth of between 5 and 50 m, more preferably at a depth in the range 10 to 30 m and most preferably at a depth of 10 to 20 m. The seismic equipment, including the source and receiver may be conventional both in its design and its use.

The present invention extends to apparatus for use in carrying out a method as claimed in any of the proceeding claims, including an EM source; a seismic source; one or more streamers carrying at least one EM field receiver and at least one seismic receiver.

The invention also extends to a method of investigating sub sea strata as described above in relation to producing a survey report, and also to a survey report produced by the methods of the invention.

In a first embodiment a vessel 10 tows a seismic source 20 and an EM source 30 on the vessel center line. A number of streamers 40a-40e are also towed behind the vessel. Five streamers are shown for example but there may be a single streamer or a plurality of streamers. On each streamer are a number of receivers 50. Six receivers are shown on each streamer for example but there may be any number of receivers on each streamer. Each receiver is separated from its neighbour by a distance “a” which may be anything within the range 1 m-500 m, more preferably 1-100 m and more preferably still 1-10 m.

The separation may be the same for EM receivers and for seismic receivers and staggered with respect to each other so that they do not interfere with each other. Alternatively, they could have different separations either on the same streamer or on different streamers such that, for example, hydrophones (seismic receivers) are placed at 1 m intervals and EM receivers are located at 10 m intervals.

Among the total network of receivers 50 on the streamers 40a-40e, there is at least one EM field receiver and at least one seismic receiver. In one embodiment, complete streamers include either just EM field receivers or just seismic receivers. In a preferred embodiment EM field receivers are located on a streamer 40c along the center line of the vessel. In this embodiment, the remaining streamers 40a, 40b, 40d, 40e carry seismic receivers. Alternatively, two EM field streamers could be off center from the center line of the vessel. For example these could be streamers 40b and 40d. In this case, with a center line EM source and two sets of receivers which are off line with the source, EM data which is both in-line and broadside can be resolved from the data collected.

In another embodiment, each streamer 40a-40e includes some EM receivers and some seismic receivers. These may be alternated (EM—seismic—EM—seismic etc) or may be grouped (for example, EM—EM—seismic—seismic—EM—EM, or 5 seismic—1 EM—5 seismic—1 EM—5 seismic . . . etc). On adjacent streamers the grouping may be the same or different. The hydrophones or seismic receivers and EM field receivers are small enough that they could both be carried on the same streamer without affecting the performance of the streamer. In this ways either a single streamer or a plurality of “mixed” streamers could be towed behind the vessel which accumulates both seismic and EM data simultaneously.

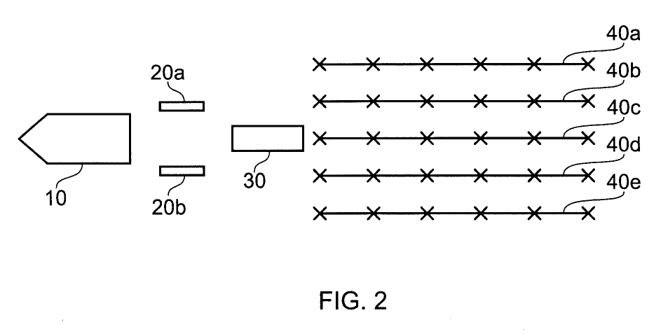

FIG. 2 shows an alternative arrangement in which the seismic source 20 is split into two sources 20a, 20b which are off the center line of the vessel. One is positioned on the starboard side of the vessel and the other is symmetrically placed on the port side of the vessel. This allows a flip flop type of seismic data to be obtained. In this case the source which triggers the acoustic signal alternates between the two sources. The EM source may also additionally comprise two dipoles, one of which is in-line with the axis of the vessel and one of which is broadside.

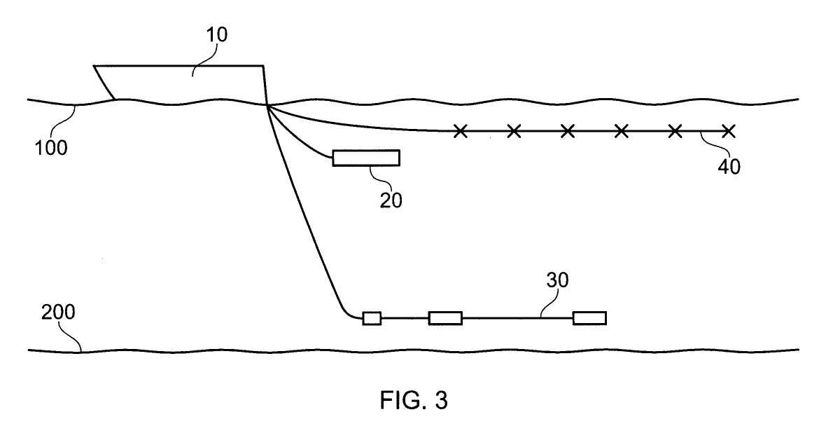

FIG. 3 shows the vertical arrangement of one embodiment of the present invention. The seismic source 20 is towed near the surface of the water 100 as are all of the streamers 40. However, the EM source 30 is towed near the seabed 200. Of course, there could be more than one seismic source (as shown in FIG. 2) and these would both be towed at substantially the same depth.

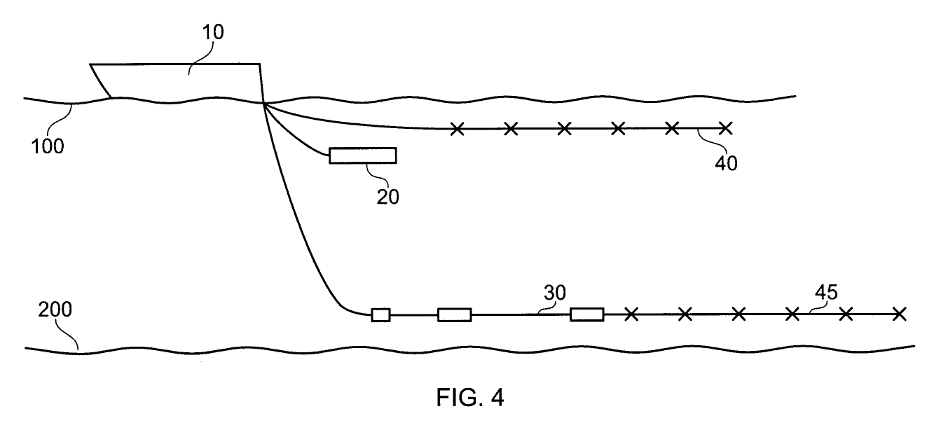

FIG. 4 shows another embodiment where the seismic source 20 and streamers carrying seismic receivers 40 are towed near the surface 100 of the water and the EM source 30 and streamers 45 carrying EM field receivers are towed near the seabed 200. In this case, the streamer 45 is shown as being attached to the end of EM source 30 but it could equally be a separate streamer which is towed near the sea bed. With these arrangements it would be possible to have two streamers along the center line of the vessel 10, a streamer carrying seismic receivers near the surface and a streamer carrying EM receivers near the seabed.

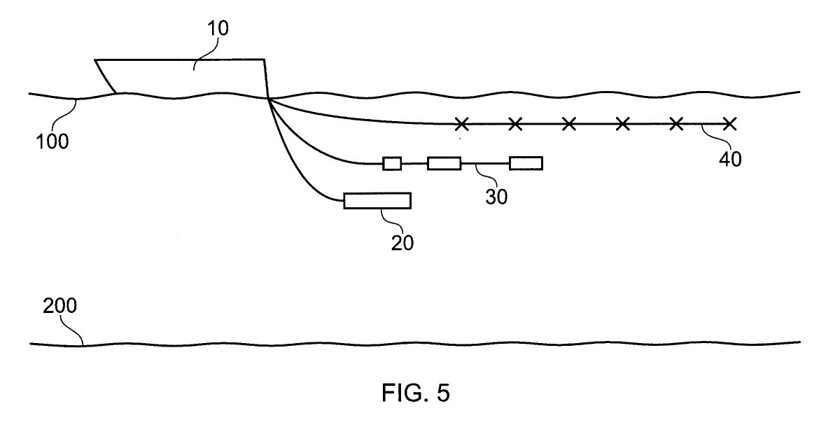

FIG. 5 shows a further embodiment where both the seismic source 20 and the EM source 30 are towed near the surface and the streamers 40 are all also towed near the surface of the water 100.

The present inventors have found that there is no cross talk between the EM source/receiver system and the seismic source/receiver system for any of the different geometries. The sources can be separately spatially during operation using existing technology so that the tow lines will not interfere with each other and the sources and streamers maintain their respective positions. This applies to both separation in the vertical positions and the horizontal positions behind the vessel.

The streamers carrying the receivers (seismic or EM or a combination of the two) can be made with similar towing properties as traditional marine seismic streamers. They can therefore all be operated using the same positioning measurement system and active steering system. In particular, EM streamers may be used in combination with existing seismic streamers utilising existing control systems.

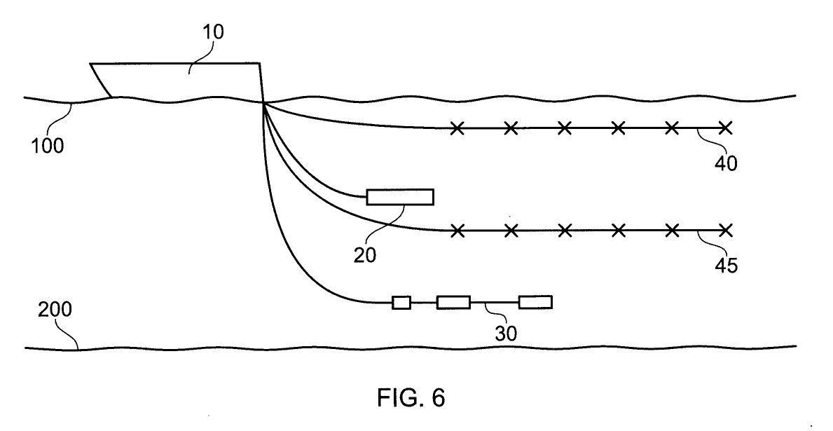

In some cases it may be desirable to operate the seismic recording using an over/under streamer configuration. This is shown in FIG. 6 where the EM source 30 is towed near the sea bed and the seismic source is towed near the surface. At least one set of streamers 40 is towed above the seismic source 20 and at least one set of streamers 45 is towed below the seismic source. These streamers may carry either just seismic receivers or just EM receivers or a combination of receivers.

The present invention can therefore offer operation efficiency by collecting both EM field and seismic data simultaneously. It is therefore possible to cover a large survey area more quickly and to obtain a more detailed picture of the subterranean strata. For a vessel which sails in a similar way to traditional seismic surveys it is now possible to obtain both EM and seismic data to produce a 2D or, more particularly, a 3D image.

1. A method of producing a survey report on a presence and a nature of a subterranean strata, the method comprising:
simultaneously towing an EM field transmitter and a seismic source behind a vessel;
towing at least one streamer behind the vessel, said streamer having EM field receivers for measuring an electric field and seismic receivers for measuring a seismic response;
applying an EM field to the strata using the EM field transmitter and detecting an EM field response using the EM field receivers;
applying a seismic event to the strata using the seismic source and detecting the seismic response using the seismic receivers;
analysing the EM field response;
analysing the seismic response and reconciling the EM field response and the seismic response to produce the survey report.

2. The method of claim 1, further comprising extracting and using phase and/or amplitude information from the EM field and seismic responses.

3. The method of claim 1, further comprising identifying a refracted wave component of the EM field response, identifying a reflected wave component of the seismic response, and using the refracted wave and reflected wave components to produce the survey report.

4. The method of claim 3, further comprising using phase and/or amplitude information from the identified components.

5. The method of claim 1, wherein the EM field transmitter comprises an electric dipole antenna.

6. The method of claim 1, wherein the EM field receivers comprise an electric dipole antenna.

7. The method of claim 1, further comprising applying the EM field and the seismic event simultaneously.

8. The method of claim 1, further comprising applying the EM field and the seismic event closely sequentially.

9. The method of claim 1, further comprising identifying the reflected wave component of the seismic response and using the reflected wave component of the seismic response to identify the subterranean strata.

10. The method of claim 1, further comprising deploying magnetic receivers on the streamers; detecting a magnetic field response; and using the magnetic field response in combination with the EM field response and the seismic response.

11. A The method of claim 1, further comprising towing the EM field transmitter and/or the seismic source near a water surface.

12. The method of claim 1, further comprising towing the seismic source near a water surface and towing the EM field transmitter is towed close to a seabed.

13. The method of claim 1, further comprising towing a second steamer, the first and second steamer being found at the same depth.

14. The method of claim 13, further comprising towing the first and second steamers near a water surface.

15. The method of claim 1, further comprising towing a second steamer, the first and second steamers being towed different depths.

16. The method of claim 15, further comprising carrying the EM field receivers close to a seabed with the first steamer and carrying the seismic receivers near a water surface with the second steamers.

17. The method of claim 1, wherein applying the EM field comprises transmitting a transmission frequency, the transmission frequency being between approximately 0.01 Hz and approximately 1 kHz.

18. The method of claim 17, wherein transmission frequency is between approximately 0.1 and approximately 20 Hz.

19. An apparatus for use in carrying out the method of claim 1, comprising an EM source;
a seismic source;
one or more streamers carrying at least one EM field receiver; and
at least one seismic receiver.

20. A survey report produced by the method of claim 1.

21. A subterranean survey system comprising:
an electromagnetic (EM) field transmitter adapted to apply an EM field to a subterranean strata;
a seismic source adapted to apply a seismic event to the subterranean strata;
at least one steamer comprising:
an EM field receiver for detecting an EM field response and measuring an electric field; and
a seismic receiver for detecting and measuring a seismic response; and
a computer including at least one data processor; and
a computer readable medium programmed with instructions to cause the computer to:
analyze the EM field response;
analyze the seismic response;
reconcile the EM field response and the seismic response; and
generate a survey indicating a presence and a nature of the subterranean strata;
wherein the EM field transmitter and the seismic source can be simultaneously towed by a vessel.
